(19) United States
(12) Patent Application Publication
(10) Pub. No.: US 2006/0171849 A1
(43) Pub. Date: Aug. 3, 2006

(54) Apparatus used to prevent cross-contamination along a platform and methods of manufacturing the same

(75) Inventors: Jennifer H. Granger, Northborough, MA (US); Robert S. Plumb, Milford, MA (US); Chris L. Stumpf, Uxbridge, MA (US); Jeffery W. Finch, Mendon, MA (US)

Correspondence Address: WATERS INVESTMENTS LIMITED;C/O WATERS CORPORATION, 34 MAPLE STREET - LG, MILFORD, MA, 01757, US

(73) Assignee: WATERS INVESTMENTS LIMITED, New Castle, DE (US)

(21) Appl. No.: 11/300,955

(22) Filed: Dec. 15, 2005

Related U.S. Application Data
(63) Continuation of application No. PCT/US04/20131, filed on Jun. 24, 2004.
(60) Provisional application No. 60/482,398, filed on Jun. 25, 2003.

(51) Int. Cl. B01L 3/00

(52) U.S. Cl. 422/99

(57) ABSTRACT

Disclosed herein is an apparatus designed to prevent cross-contamination of a fluid along the surface of a platform like a laser desorption target or multi-well plate. In particular, the apparatus comprises a cover slip that is disposed in apposition to the platform. This cover slip has an upper surface and a lower surface, wherein the lower surface is in apposition to the platform. Optionally, the cover slip has one or more defined orifices that extend from the upper surface through to the lower surface such that fluid communication is maintained from the upper surface of the cover slip to the surface of the platform interfacing with the lower surface of the cover slip.

### CROSS REFERENCE TO RELATED APPLICATIONS

This application claims benefit of and is a continuation of International Application No. PCT/US2004/020131, filed Jun. 24, 2004 and designating the United States, which claims benefit of a priority to U.S. Provisional Application No. 60/482,398 filed Jun. 25, 2003. The content of these applications are expressly incorporated herein by reference in its entirety.

### STATEMENT ON FEDERALLY SPONSORED RESEARCH

NOT APPLICABLE

### BACKGROUND OF THE INVENTION

A commonly employed tool in research and clinical laboratories is the multi-well plate. Multi-well plates are versatile and can be used for any number of analytical techniques required to generate data for multiple samples. It should also be mentioned that multi-well plates could also be used to perform biochemical procedures like nucleic acid amplification. These plates are composed of a plurality of wells or receptacles used to receive liquid samples. The wells are generally preformed and are placed uniformly throughout a substrate platform. For example, there are plates that have ninety-six wells situated within the platform. The dimensions of the individual wells vary depending upon the plate used, however, it is typical that the dimensions for any well part of the same platform are equivalent. Typically, the wells of a ninety-six well plate are larger, for example, by volume, when compared to a three hundred eighty-four microtiter plate.

The chemical and biological arts have long referred to multi-well devices as plates, even though such devices are not flat, featureless articles. Indeed, some multi-well devices are precision molded with many features. Unfortunately, the mass spectroscopy art has used the identical term “plate” to denote a platform having a surface for receiving sample for laser ionization. The term “plate” will be used herein to denote multi-well devices, such as a typical ninety-six well device, and the term “platform” to denote devices for laser ionization such as DIOS and MALDI plates.

In operation, a practitioner will employ a multi-well plate for analyzing a number of samples. Typically, an aliquot of a sample is introduced into a single well. This step is repeated for each sample to be analyzed or processed, or for each analysis to be performed on the sample. A common difficulty encountered by practitioners is cross-contamination amongst neighboring wells. This cross-contamination can have dramatic consequences on the analysis or procedure being performed.

In the case of the multi-well plate, the receptacles are preformed. However, it is sometimes desirable to apply a preparation to the surface of a platform devoid of preformed wells such that that which is applied extends vertically beyond the surface of the platform. For example, during sample preparation of a laser desorption MS target it is necessary to apply an analyte to a focal point located on a surface of the target. Absent a structure to contain the analyte (e.g., a well), bleeding (or horizontal displacement) of the analyte may occur, thereby, potentially contaminating other analyte foci and loosing capability for concentrating the sample.

Currently, there is a need for a structure that can be used to insure confinement and maximum concentration of a liquid preparation within a defined locus.

### SUMMARY OF THE INVENTION

The present invention pertains to an apparatus designed to prevent cross-contamination of a fluid along a surface of a platform as well as to facilitate the concentration of a sample. In particular, the apparatus comprises a cover slip that when structurally in apposition to a platform, minimizes or eliminates horizontal displacement of a fluid applied to a surface of a platform. This cover slip has a substrate with an upper surface and a lower surface, wherein the lower surface is in apposition to the platform. Optionally, the cover slip has one or more defined orifices that extend from the upper surface through the substrate to the lower surface such that fluid communication is maintained from the upper surface of the cover slip to the surface of the platform interfacing with the lower surface of the cover slip.

In one embodiment, a cover slip of the present invention is in apposition with a platform such that dispersion of a fluid from between the interface defining the junction of the cover slip and platform is minimal or non-existent. In a particular aspect of this embodiment, an adherent material disposed along the lower surface of the cover slip is used to effectuate adherence of the cover slip to the platform. In another aspect of this embodiment, a non-permanent adherent material is used, and therefore, the cover slip is removably affixed to the platform. In one aspect, the cover slip is adsorbed onto a platform such that fluid will not permeate into and through the interface formed between the cover slip and platform.

In one embodiment, the apparatus of the present invention comprises multiple cover slips. In this embodiment, each cover slip comprises an upper surface and a lower surface. One or more of the cover slips interfaces with a platform via their lower surface. In a particular aspect, the cover slips in apposition with the platform comprise one or more defined orifices extending from their upper surface through to the lower surface, thereby permitting fluid communication between the upper surface of a cover slip and the platform. In another aspect, the cover slip has no orifices. In yet another aspect, the cover slip has one or more zones of orifices while the remainder of the cover slip is free of orifices. In this embodiment, one or more of the cover slips can interface with other cover slips forming a sandwich-like structure. For example, the lower surface of one cover slip can interface with the upper surface of another cover slip. Additionally, the superior cover slip (or that cover slip which lies atop of another cover slip and is distal to the platform) can be devoid of any orifices. In this embodiment, the superior cover slip can be removably affixed to the inferior cover slips (or those cover slips proximal to the platform viz. a superior cover slip). This configuration could be used to cover one or more of the orifices of an inferior cover slip that is disposed adjacently with a platform, thereby creating layers of access, i.e., access to the interfacing surface of the platform.

In one embodiment, an apparatus for containing one or more discreet volumes of liquid in a predetermined pattern upon a substantially planar surface of a platform is described. In this embodiment, the platform is for receiving one or more samples and holding these samples during a procedure, such as laser ionization. The platform of the present embodiment comprises a cover slip having a top surface and a bottom surface. The bottom surface is constructed and arranged for being received on the planar surface of the platform. The cover slip has one or more openings extending from the top surface to the bottom surface in order to create a plurality of containment vessels. These containment vessels are used to facilitate the deposition of the samples into discreet positions along the planar surface of the platform.

In another embodiment, a method of performing laser ionization is described. This method comprises providing a platform which has a substantially planar surface, wherein the platform receives one or more samples and retains the samples during a procedure, such as laser ionization. Next, a cover slip is provided in which the cover slip has a top surface and a bottom surface, wherein the bottom surface is constructed and arranged for being received on the planar surface of the platform. In this embodiment, the cover slip has one or more openings extending from the top surface to the bottom surface in order to create a plurality of containment vessels. The cover slip is next affixed (or disposed) adjacent to the planar surface of the platform in order to create a plurality of containment vessels for containing discreet volumes of sample. Finally, one or more samples are deposited within said containment vessels.

The present invention pertains to methods of manufacturing the cover slips presented herein. In one embodiment, a mold apparatus comprising a base, side walls and one or more columns is used to construct a cover slip of the present invention having orifices. In another embodiment, a mold apparatus comprises a base devoid of columns (not shown). In still another embodiment, a base comprising zones of columns and zones devoid of columns are contemplated to be within the scope of this invention. The side walls are position appropriately about the perimeter of the base. Securing the side walls about the base can be accomplished by methods well known in the art. The side walls of the present embodiment are used to prevent extrusion of cover slip substrate material from the mold apparatus. Once the side walls are properly positioned about the base, a suitable cover slip substrate material can be dispensed onto the mold apparatus. In a particular aspect, the substrate material is in a liquid form prior to and during the process of dispensing it into the mold apparatus. Once the substrate material has been dispensed into the mold apparatus, an appropriate amount of time is permitted to allow the substrate to cure. This time is dependent upon the substrate material used. Once the substrate material has cured, it can be lifted out of the mold apparatus 24 and used.

In another embodiment, the present invention comprises a mold apparatus having a base with a plurality of receptacles. Each of the base receptacles can receive either a column or plug. The columns of the present invention can be of any size and shape, but essentially can be characterized as either columns producing complete orifices or incomplete orifices in the final cover slip. Columns of the present invention can be comprised of materials like stainless steel, polymer, wax, resin or alike, including combinations thereof. A plug is simply a place holder situated along the base where no orifice is contemplated to be within a completed cover slip. Plugs of the current invention can be comprised of materials like stainless steel, polymer, wax, resin or alike including combinations thereof. In a particular aspect, both the column and plug elements can be snap-fitted into the receptacles of the base. However, other securing mechanisms well known to those skilled in the art are contemplated to be within the scope of this invention. The receptacles of the base have the requirement that they be complementary to either a column fitting or plug fitting so that they can receive either a column or plug.

### BRIEF DESCRIPTION OF THE DRAWINGS

FIG. 1 is a perspective view of one embodiment of a cover slip;

FIG. 2 depicts the use of a cover slip with a ninety-six well plate;

FIG. 3 depicts the use of a cover slip in the fabrication of a DIOS chip;

FIG. 4 depicts a multi-cover slip embodiment;

FIG. 5 depicts the steps involved in the manufacture of a cover slip; and

FIG. 6 (a) through (d) illustrate various steps of manufacture for a cover slip of the present invention.

### DETAILED DESCRIPTION

The present invention pertains to an apparatus designed to prevent cross-contamination of a fluid along a platform such as a laser desorption mass spectrometric target or multi-well plate. Moreover, the apparatus of the present invention is designed to facilitate concentration of a sample. In particular, the apparatus comprises a cover slip that is disposed in apposition to the platform. This cover slip has an upper surface and a lower surface, wherein the lower surface is in apposition to the platform. Optionally, the cover slip has one or more defined orifices that extend from the upper surface through to the lower surface such that fluid communication is maintained from the upper surface of the cover slip to the surface of the platform interfacing with the lower surface of the cover slip.

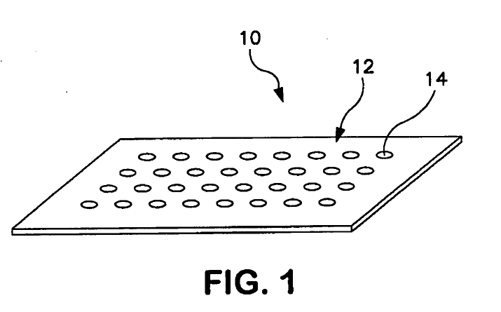

Referring to FIG. 1 of the drawings, cover slip 10 is shown having multiple orifices 14 defined within a substrate 12. In the embodiment depicted by FIG. 1, the cover slip 10 has a rectangular geometry. However, the cover slip of the present invention can assume any geometrical configuration, such as a circular geometry, a triangular geometry, a square geometry, and alike. In fact, a practitioner can obtain a cover slip having one geometrical configuration and convert it into another geometrical configuration using methods well known to those skilled in the art. Not only is geometrical variation embraced by this invention, but also, the dimensions of the cover slip may vary. The size of the cover slip of the present invention can be similar to that of a common credit card to that of a conventional ninety-six well plate. The dimensions of the cover slip can be, for example, from about 1.5″×1.0″ to about 12″×12″, however, it is important to note that the size contemplated is limitless.

The cover slip 10 depicted in FIG. 1 has multiple defined orifices 14 arrayed throughout the substrate 12. In one aspect, the cover slip 10 can be devoid of orifices 14 completely or in certain regions of the substrate 12. The diameter of the orifices 14 can vary depending upon the needs of the practitioner. The arrangement of the orifices 14 about the substrate 12 can vary as well. In some situations, an incomplete orifice is necessary. An incomplete orifice is an orifice in which not all of the substrate material has been removed from a defined locus. This feature of the present invention permits a practitioner to customize his cover slip. The practitioner can complete an incomplete orifice using methods well known to those in the art. As with the cover slip 10 as a whole, the orifices 14 of the cover slip 10 can assume any geometrical configuration.

Materials suitable for a substrate of a cover slip for the present invention includes, but is not limited to, poly(dimethylsiloxane), waxes, epoxies, resins and combinations thereof. In one aspect, poly(dimethylsiloxane) (PDMS) is used to construct the cover slip. Poly(dimethylsiloxane) can be reversibly adhered to silicon and stainless steel. In the case of silicon, PDMS can also be made to permanently bond to the surface via high-temperature treatment at around 330° C. Additionally PDMS is a flexible, but durable substance. In one aspect of the present invention, the material used to construct the cover slip is optically transparent. In a particular aspect, wavelengths generally equal to or greater than 200 nm can penetrate the substrate of the cover slip.

Practitioners often employ multi-well plates for conducting analysis of their samples. A common problem faced by these practitioners is cross-contamination of the wells by reagents or samples added. This contamination can be effectuated by handling the multi-well plate in a manner that causes agitation of the fluid within the wells to such an extent that fluid is transferred inadvertently between individual wells. Contamination can occur due to a faulty dispensing apparatus or a shaky practitioner's hand dispensing reagent or sample into a receptacle well. This cross-contamination can have dramatic consequences upon the analysis or procedure being performed.

Multi-well plates are versatile and can be used for any number of analytical techniques required to generate data for multiple samples. These multi-well plates are composed of a plurality of wells or receptacles used to receive liquid samples. The wells are generally preformed and are placed uniformly throughout a substrate platform. For example, there are plates that have ninety-six, three hundred eighty-four, etc. wells situated within the platform. The dimensions of the individual wells vary depending upon the plate used, however, it is typical that the dimensions for any well part of the same platform are equivalent.

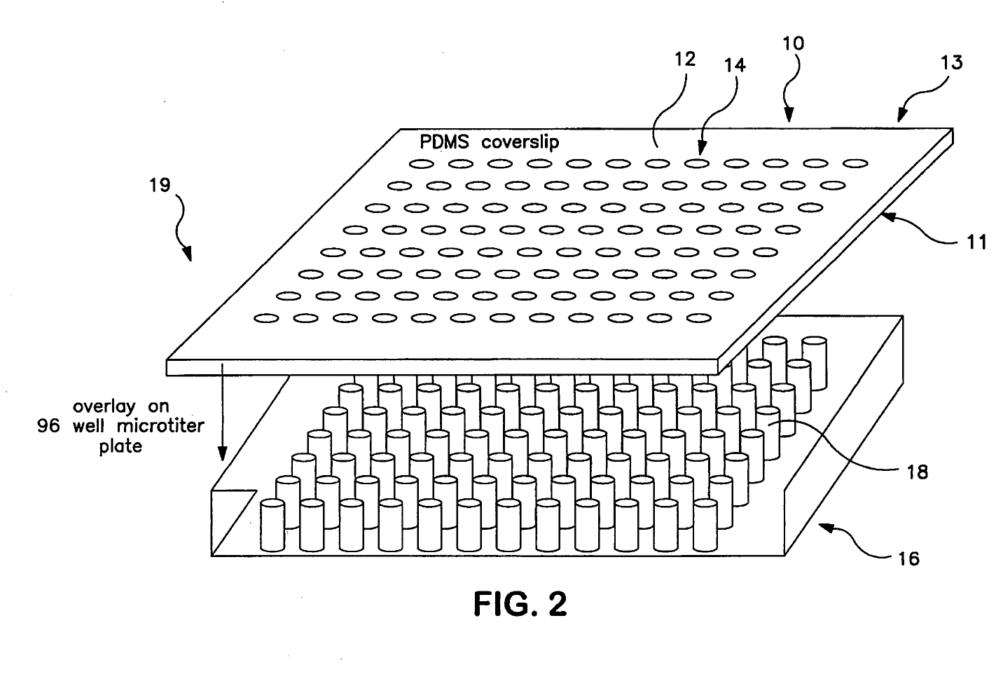

The apparatus 19 of the present invention can be employed in order to alleviate the problem of contamination in multi-well plates (or platforms) 16, additionally, it can facilitate the concentration of sample. See FIG. 2. The apparatus 19 of the present invention comprises a cover slip 10 wherein the lower surface 11 is in apposition to the multi-well platform 16. The cover slip 10 of the present invention can have one or more orifices 14 corresponding to wells 18 used in the multi-well platform 16. For example, if a multi-well platform contains forty-eight wells that potentially receive sample and/or reagents, then a forty-eight orifice cover slip can be used to prevent cross-contamination between the wells of the platform. The orifices 14 can extend from the upper surface 13 through to the lower surface 11 of the cover slip. Alternatively, an incomplete orifice 14 can be formed whereby a channel is formed beginning at the upper surface 13 of the cover slip 10 but does not penetrate thoroughly through the lower surface 11. The orifices 14 of the cover slip 10 can be arranged such that they correspond with the openings of the wells 18 disposed along the platform 16. Moreover, if a fraction of wells 18 are going to be employed, for example twenty out of the forty-eight wells 18, then the practitioner can obtain or manufacture a cover slip 10 according to the present invention that has twenty orifices 14 that correspond isomorphically with the active wells.

Alternatively, a practitioner can use multiple cover slips. Assuming that the practitioner is using a forty-eight well platform, a cover slip having forty-eight orifices that correspond with the forty-eight wells can be disposed in apposition to the multi-well platform. If, for example, only half or twenty-four of the wells are to be used, then another cover slip without orifices can be disposed adjacently along the superior surface of the cover slip having the orifices in such a manner as to form a sandwich-like apparatus in which the cover slip orifices that are not active are blocked. This invention invites customization.

In the case of the multi-well platform, the receptacles are preformed. However, it is sometimes desirable to apply a liquid preparation to a surface of a platform lacking in preformed wells. Such is the case when fabricating a laser desorption MS target, e.g., a DIOS chip. The laser desorption MS target can be comprised of etched silicon, machined stainless steel, polymers or other like materials. This process involves the application of analyte(s) to the surface of the chip. Absent a structure to contain the analyte, bleeding of the analyte may occur thereby contaminating other analyte dispositions along the surface of the chip. Further, without an apparatus of the present invention, concentration of the analyte added is essentially non-existent.

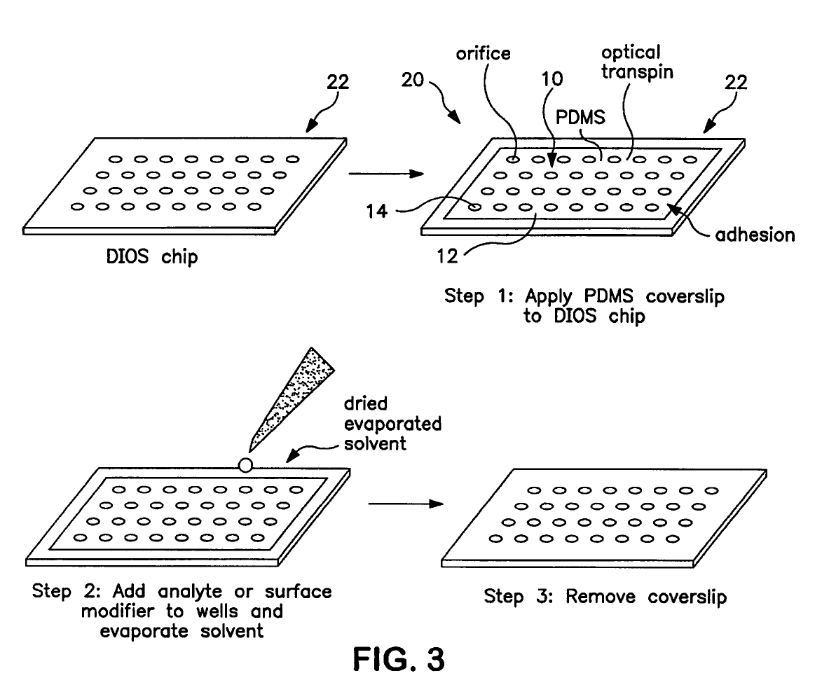

The present invention provides an apparatus 20 that minimizes cross-contamination along a planar surface of a platform 22, such as a DIOS chip 22. See FIG. 3. The apparatus 20 comprises a platform 22 and a cover slip 10 adjacently disposed along a surface of the platform 22. Optionally, the cover slip 10 has one or more orifices 14 such that fluid can be deposited upon the surface of the platform 22 disposed in apposition with the cover slip 10.

Moreover, the cover slip of the present invention facilitates the concentration of deposited samples. For example, following the deposition of sample material onto a flat, planar surface such as a DIOS chip in conjunction with a cover slip having one or more orifices the sample becomes concentrated as evaporation occurs within the confines of a sample pocket defined by the orifices of the cover slip.

In one embodiment, a cover slip of the present invention is in apposition with a platform such that dispersion of a fluid from between the interface defining the junction of the cover slip and platform is minimal or non-existent. In a particular aspect of this embodiment, an adherent material disposed along the lower surface of the cover slip is used to effectuate adherence of the slip to the platform. Adherent materials suitable to permanently (or semi-permanently) affix the cover slip to the platform includes, but is not limited to, glues like poly(acrylates) as well as other adhesives known to those skilled in the art. However, some substrate material does not require any additional adherent materials, such is the case when poly(dimethylsiloxane) is the substrate material. Inherent with poly(dimethylsiloxane) is the ability of this material to affix to the surface of a platform forming a junction with the platform such that extrusion of material is minimal or non-existent. In another aspect of this embodiment, a non-permanent adherent material known to those skilled in the art is used and therefore the slip is removably affixed to the platform. In one aspect, the cover slip is adsorbed onto a platform such that fluid will not permeate into and through the interface formed between the slip and platform.

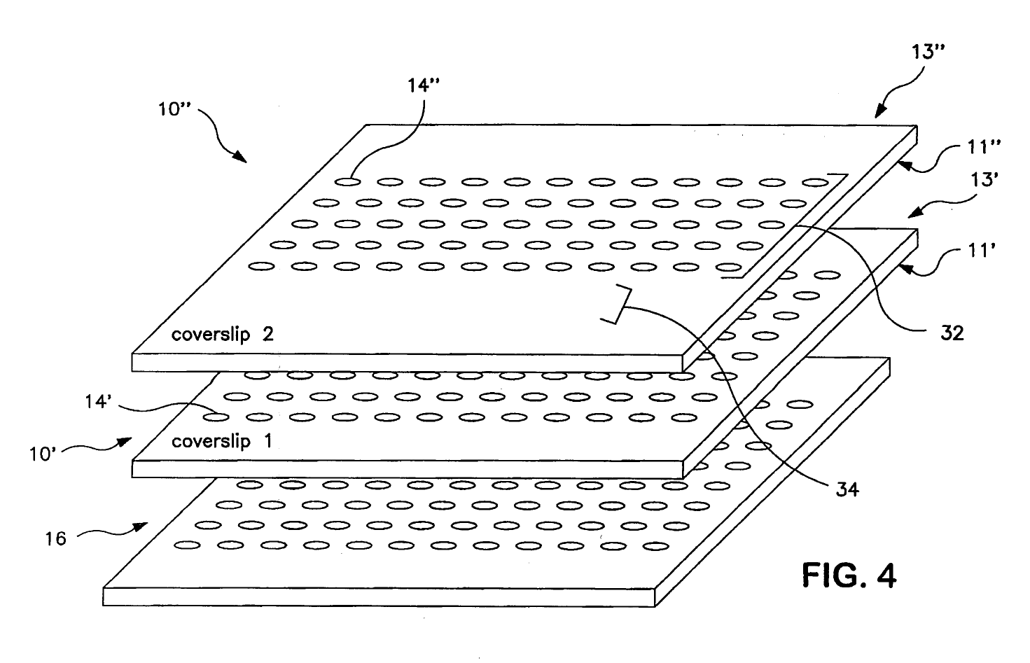

In another embodiment, the apparatus of the present invention comprises multiple cover slips, 10′, 10″. See FIG. 4. In this embodiment, each cover slip 10′, 10″ comprises an upper surface 13′, 13″ and a lower surface 11′, 11″. One or more of the cover slips 10′ interfaces with a platform 16 via their lower surface 11′, while other cover slips 10″ are disposed along all or part of the superior surface of one or more cover slips 10′ disposed along the platform 16. A sandwich-like design can be envisaged in this embodiment.

In a particular aspect, the cover slips 10′, 10″ in apposition with the platform comprise one or more defined orifices 14′, 14″ extending from their upper surface 13′, 13″ through to the lower surface 11′, 11″, thereby permitting fluid communication between the upper surface of a cover slip and the platform 16. In another aspect, one or more of the cover slips has no orifices. In yet another aspect, the cover slip has one or more zones of orifices 32 while the remainder zone(s) 34 of the cover slip is free of orifices. In this embodiment, one or more of the cover slips can interface with other cover slips. For example, the lower surface 11″ of one cover slip 10″ can interface with the upper surface 13′ of an inferior cover slip 10′. Additionally, the superior cover slip 10″ (or that cover slip which lies atop of another cover slip and is distal to the platform) can be devoid of any orifices. This sandwich-like configuration could be used to cover one or more of the orifices of an inferior cover slip 10′, thereby creating layers of access, i.e., access to the surface of the platform.

In one embodiment of the present invention, an apparatus for containing one or more discreet volumes of liquid in a predetermined pattern upon a substantially planar surface of a platform is described. In this embodiment, the platform receives one or more samples and retains the samples during processing, such as laser ionization.

In this embodiment, the apparatus comprises a cover slip which has a top surface and a bottom surface. In one aspect, the bottom surface is constructed and arranged for being received on the planar surface of the platform for performing. In this aspect of the invention, the cover slip has one or more openings that extend from the top surface to the bottom surface in order to create a plurality of containment vessels when the cover slip is disposed along on the platform. These containment vessels facilitate the deposition of the sample in discreet positions on the planar surface of the platform.

In one aspect of this embodiment, a multi-well means or platform is used in conjunction with a cover slip of the present invention. The cover slip in this aspect has one or more openings positioned to cooperate with the multi-well device. The multi-welled dispensing means can be a multi-well device consisting of multiples of ninety-six wells.

The cover slip in this embodiment can comprise an adhesive coating used to secure the cover slip on the planar surface of the platform. Alternatively, the cover slip comprises a composition that is used to adhere to the planar surface of the platform through electrostatic interactions.

In this embodiment, the cover slip can be removable, thus allowing a sample to be received followed by liquid evaporation by removing the cover slip.

The cover slip of the present embodiment has a thickness and openings such that one or more containment vessels are created in which each vessel has a volume of from about 5 to about 10 μL.

In another embodiment of the present invention, a platform assembly for containing one or more discreet volumes of liquid in a predetermined pattern upon a substantially planar surface is described. The assembly of this embodiment comprises a platform having a substantially planar surface, wherein the platform is capable of receiving one or more samples and retains the samples during a procedure, such as laser ionization. The assembly also comprises a cover slip with a top surface and a bottom surface, wherein the bottom surface is constructed and arranged for being received on the planar surface of the platform. In one aspect, the cover slip has one or more openings extending from the top surface to the bottom surface in order to create a plurality of containment vessels.

In another embodiment of the present invention, a method of performing laser ionization is described. This method comprises providing a platform that has a substantially planar surface. The platform of the present embodiment is capable of receiving one or more samples and will retain the samples during a procedure, such as laser ionization. Next, a cover slip is provided in which the cover slip has a top surface and a bottom surface, wherein the bottom surface is constructed and arranged for being received on the planar surface of the platform. In one aspect, the cover slip has one or more openings that extend from the top surface to the bottom surface in order to create a plurality of containment vessels. The cover slip is then affixed to the planar surface of the platform in order to create a plurality of containment vessels for containing discreet volumes of sample. Finally, one or more samples are deposited in the containment vessels. This method alternatively comprises the step of removing liquid from the sample. Additionally, the method can comprise the step of removing the cover slip from the planar surface. The method of the present embodiment can additionally comprise the step of irradiating the samples present.

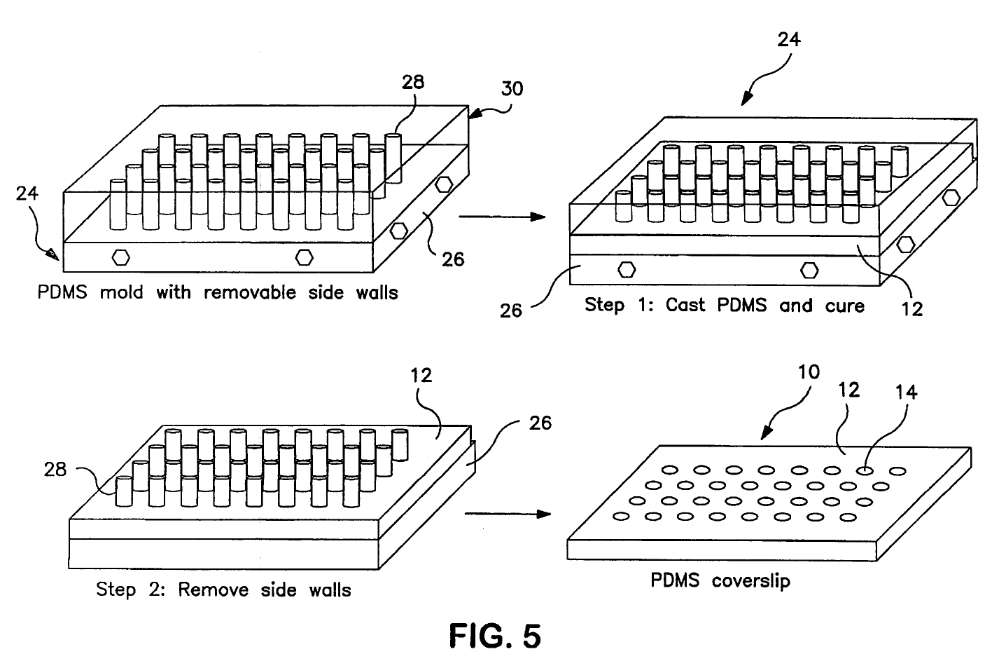

The present invention pertains to methods of manufacturing the cover slips articulated herein. In one embodiment, referring to FIG. 5, a mold apparatus 24 comprising a base 26, side walls 30 and one or more columns 28 is used to construct a cover slip of the present invention having orifices. In another embodiment, a mold apparatus comprises a base devoid of columns (not shown). Materials suitable for the base include Teflon, plastic, ceramic, glass, metal such as stainless steel and combinations thereof. Returning to FIG. 5, side walls 30 are position appropriately about the base 26 such that substrate material added to the mold cannot extrude through the junction formed by the side walls 30 and base 26. Securing the side walls 30 about the base 26 can be accomplished by methods well known in the art. For example, an adhesive (like a conventional glue known to those skilled in the art) can be used at the interface between a side wall and an external lateral surface of the base 26. Additionally, screw-type fixation can be used to secure the side walls 30 onto the base 26. Snap-fit features can be included allowing a side wall to be snapped-fit into position about the base. Other well known mechanisms for securing the side walls 30 onto the base 26 are contemplated and are within the scope of this invention.

The side walls 30 of the present embodiment are used to prevent extrusion of cover slip substrate material from the mold apparatus 24. See FIG. 5. Materials suitable for the side walls include Teflon, plastic, glass, metal such as stainless steel and combinations thereof. Once the side walls 30 are properly positioned about the base 26, suitable cover slip substrate material can be dispensed onto the mold apparatus 24. In a particular aspect, the substrate material is in a liquid form prior to and during the process of dispensing it onto the mold apparatus 24. Suitable substrate material includes, but is not limited to, poly(dimethylsiloxane), waxes, epoxies, resins and combinations thereof. Once the substrate material has been dispensed onto the mold apparatus 24, an appropriate amount of time is permitted to allow the substrate to cure. This time is dependent upon the substrate material used. For example, if poly(dimethylsiloxane) requires about 2 hours at around 65° C. Once the substrate material has cured, it can be lifted out of the mold apparatus 24 and used.

Variations of manufacturing a cover slip are contemplated by this invention. For example, the columns 28 used to produce orifices within the cover slip can be such that only partial penetration into the substrate is made, thereby forming incomplete orifices. This can be accomplished easily by having the length of the vertical axis of the columns to be such that when the substrate material is introduced into the mold apparatus, the substrate material level rises above the apex of the column.

A combination of complete and incomplete orifices are envisaged to be within the scope of the present invention. This embodiment can be effectuated by having a mold apparatus that comprises a mixture of columns, i.e., those that will form complete orifices as well as those that will form only incomplete orifices. The ease of design change can be accomplished by using a mold apparatus that is amenable to receiving different size columns. For example, it is within the scope of this invention that a mold apparatus comprises a base in which columns can be added to it (as well as subtracted from it) in such a manner as desired by a practitioner. Securing a particular column to the base can be accomplished by methods well known in the art, for example, using a snap fit mechanism. This type of customization allows for cover slip design in which a cover slip can have regions (or zones) of complete orifices, incomplete orifices, and no orifices all on one cover slip.

Various dimensions of the mold apparatus, along with its attendant parts, are encompassed to be within the scope of this invention. These variations reflect the variation of the dimensions of the cover slip articulated above. The mold is constructed such that there is a direct correlation between it and the dimensions of the resulting cover slip. If, for example, a 1″×1″ slip is desired, then the inner dimensions of the mold will be 1″×1″.

In one embodiment, the present invention comprises a mold apparatus comprising a base having receptacles. Each receptacle can receive either a column or plug. The columns of the present invention can be of any size, but essentially can be characterized as either columns producing complete orifices or incomplete orifices. A plug is simply a place holder situated along the base where no orifice is contemplated to be within a completed cover slip. Columns of the present invention can be comprised of stainless steel, polymer, wax, resin and a combination thereof. Plugs of the current invention can be comprised of stainless steel, polymer, wax, resin and a combination thereof. In a particular aspect, both the column and plug elements can be snap-fitted into the receptacles of the base. One aspect envisages that the individual receptacles are female and the column and plug elements are male. However, other securing mechanisms are contemplated to be within the scope of this invention.

The receptacles of the base has the requirement that they be complementary to either a column fitting or plug fitting. The “fitting” is the actual element that interacts with a receptacle. One configuration of a column is a circular element, however, other geometrical configurations are embraced within the scope of this invention. The same is true for plugs.

The features and other details of the invention will now be more particularly described and pointed out in the following example. It will be understood that the particular embodiments of the invention are shown by way of illustration and not as limitations of the invention. The principle features of this invention can be employed in various embodiments without departing from the scope of the invention.

### EXAMPLE

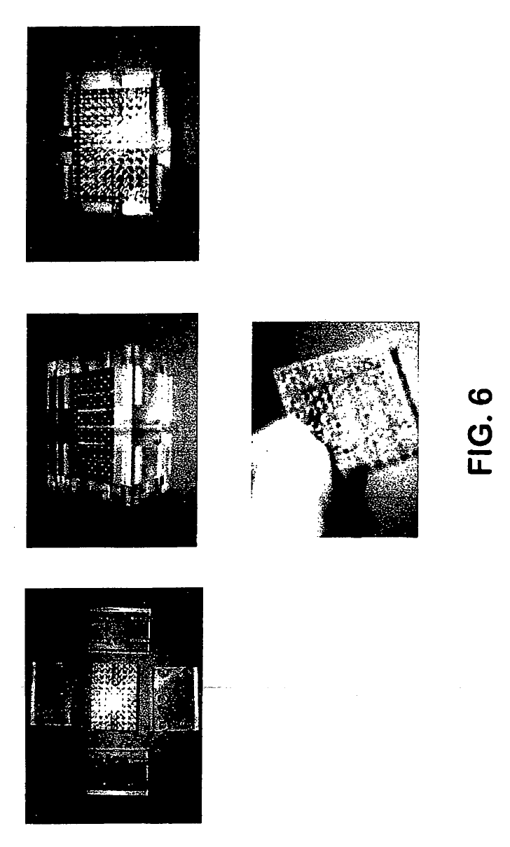

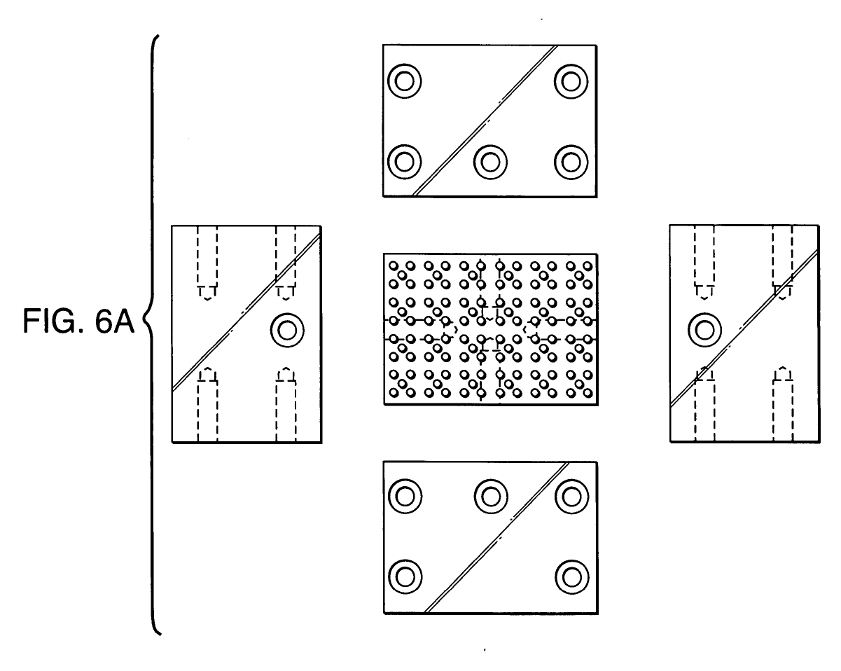

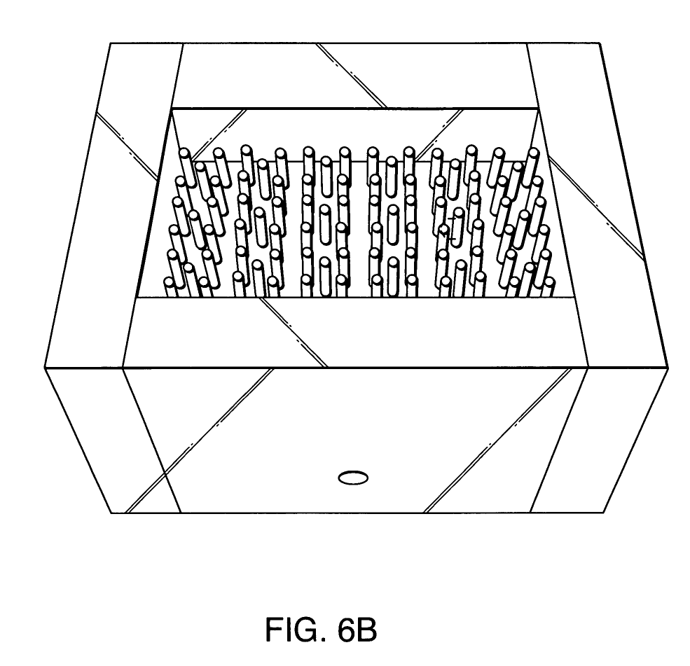

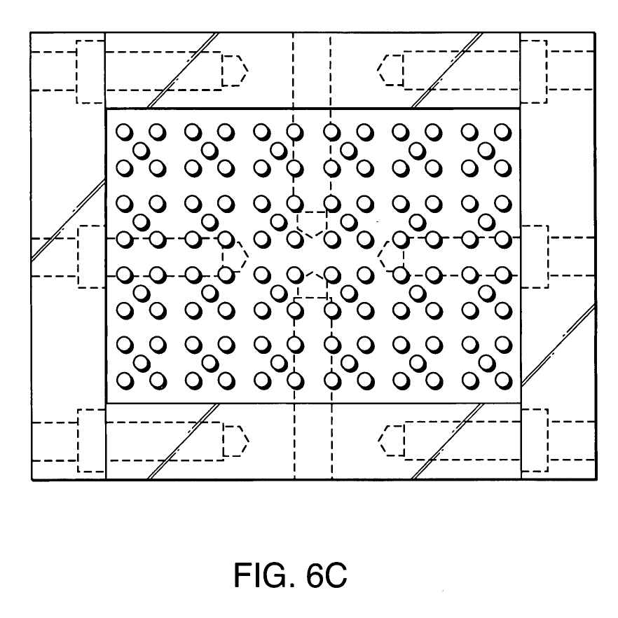

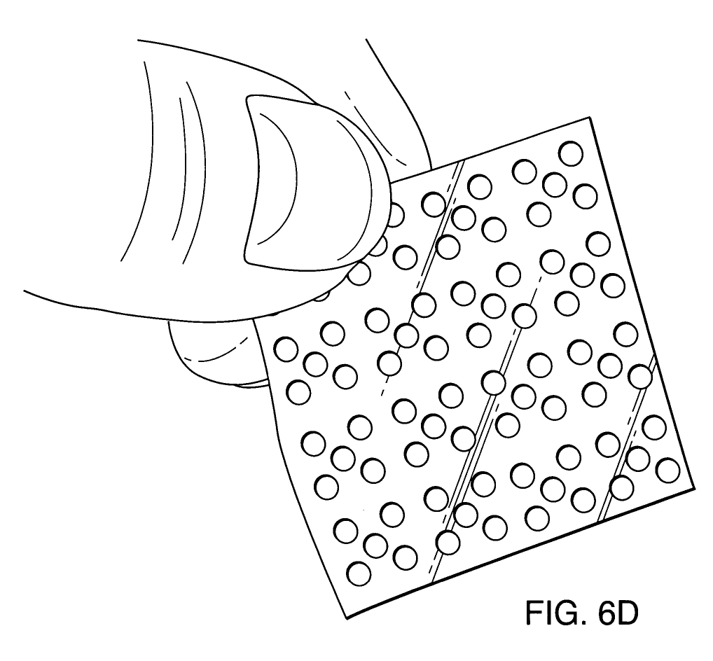

An example of the mold used to fabricate a PDMS coverslip for a MALDI target plate is shown in FIG. 6 (a)-(c). A Lexan base was cut to the exact dimensions of a MALDI target plate and holes were drilled using a CNC lathe according to the exact distances of the spot areas on the MALDI target plate obtained from the original CAD drawing. After machining the holes into the Lexan base, stainless steel pins were hammered into the holes. Side walls were also machined out of Lexan and holes for attachment screws were drilled and tapped. The final assembly is illustrated in FIGS. 6 (b) and (c). PDMS elastomer was then poured over the pins in the mold until an estimated thickness of 1 mm was reached. The PDMS was cured in an oven at 65° C. for 2 hours. After cooling to room temperature, the sidewalls were removed and the PDMS coverslip was extricated from the mold using a pair of tweezers.

While this invention has been particularly shown and described with references to specific embodiments, it will be understood by those skilled in the art that various changes in form and details may be made therein without departing from the spirit and scope of the invention as defined by the appended claims.

What is claimed is:

1. An apparatus for preventing cross-contamination along a surface of a platform, comprising a cover slip having an upper surface and a lower surface constructed and arranged for being received on a substantially planar surface of said platform, wherein one or more defined orifices extend from said upper surface of said cover slip through said lower surface of said cover slip.

2. The apparatus of claim 1, wherein said lower surface of said cover slip is in apposition to said substantially planar surface of said platform.

3. The apparatus of claim 2, wherein said lower surface adheres to said substantially planar surface of said platform.

4. The apparatus of claim 3, wherein said lower surface adheres to said substantially planar surface of said platform via adsorption.

5. The apparatus of claim 3, wherein said lower surface comprises an adherent material.

6. The apparatus of claim 5, wherein said adherent material is selected from the group consisting of a glue like poly(acrylates) and alike.

7. The apparatus of claim 1, wherein said cover slip is composed of a material selected from the group consisting of poly(dimethlysiloxane), waxes, epoxies, resins and combinations thereof.

8. The apparatus of claim 7, wherein said cover slip is composed of poly(dimethylsiloxane).

9. The apparatus of claim 1, wherein said cover slip is composed of an optically transparent material.

10. An apparatus for preventing cross-contamination along a substantially planar surface of a platform constructed and arranged for being received on a substantially planar surface of said platform, comprising two or more cover slips each having an upper surface and a lower surface, wherein one or more defined orifices are disposed along at least one cover slip.

11. A mold apparatus used to construct a cover slip comprising a base, wherein said base has one or more receptacles capable of receiving either a column or plug element.

12. The apparatus of claim 11, wherein said column comprises a material selected from the group consisting of stainless steel, polymer, wax, resin and a combination thereof.

13. The apparatus of claim 11, wherein said plug comprises a material selected from the group consisting of stainless steel, polymer, wax, resin and a combination thereof.

14. The apparatus of claim 11, wherein said base comprises a material selected from the group consisting of Teflon, plastic, ceramic, glass, metal such as stainless steel, and combinations thereof.

15. The apparatus of claim 11, wherein said side wall comprises a material selected from the group consisting of Teflon, plastic, glass, metal such as stainless steel and combinations thereof.

16. An apparatus for containing one or more discreet volumes of liquid in a predetermined pattern upon a substantially planar surface of a platform, said platform for receiving one or more samples and for holding said samples during laser ionization, said apparatus comprising:
a cover slip having a top surface and a bottom surface, said bottom surface constructed and arranged for being received on said substantially planar surface of said platform for performing laser ionization, said cover slip having one or more openings extending from said top surface to said bottom surface to create a plurality of containment vessels as said cover slip is received on said platform, to facilitate deposition of said sample in discreet positions on said substantially planar surface of said platform.

17. The apparatus of claim 16, wherein said cover slip has one or more openings positioned to cooperate with a multi-well dispensing means.

18. The apparatus of claim 17, wherein said multi-welled dispensing means is selected from the group consisting of multi-well devices consisting of multiples of ninety-six and devices sized to cooperate with such multi-well devices.

19. The apparatus of claim 16, wherein said cover slip has a coating of adhesive for being received on said substantially planar surface of said platform.

20. The apparatus of claim 16, wherein said cover slip comprises a composition that adheres to said substantially planar surface through electrostatic interactions.

21. The apparatus of claim 16, wherein said cover slip is removable, allowing said sample to be received and liquid evaporation, followed by the removal of said cover slip.

22. The apparatus of claim 16, wherein said cover slip is transparent.

23. The apparatus of claim 16, wherein said cover slip has a thickness and said openings have a dimension to create a containment vessel having a volume of from about 5 to about 10 μL.

24. The apparatus of claim 16, wherein said apparatus comprises a first cover slip and at least one second cover slip, wherein said first and second cover slips each have a thickness and said openings to create a containment vessel having a volume of from about 5 to about 10 μL, and wherein second cover slip is affixed to said first cover slip thus creating a containment vessel with an additive volume contributed thereto by each cover slip.

25. A platform assembly for containing one or more discreet volumes of liquid in a predetermined pattern upon a substantially planar surface, comprising:
a platform having a substantially planar surface, wherein said platform receives one or more samples and retains said samples during laser ionization; and
a cover slip having a top surface and a bottom surface, wherein said bottom surface constructed and arranged for being received on said substantially planar surface of said platform for performing laser ionization, wherein said cover slip has one or more openings extending from said top surface to said bottom surface to create a plurality of containment vessels as said cover slip is received on said platform.

26. A method of performing laser ionization, comprising the steps of:
providing a platform having a substantially planar surface, wherein said platform receives one or more samples and retains said samples during laser ionization;
providing a cover slip having a top surface and a bottom surface, wherein said bottom surface is constructed and arranged for being received on said substantially planar surface of said platform, wherein said cover slip has one or more openings extending from said top surface to said bottom surface to create a plurality of containment vessels as said cover slip is received on said platform;
affixing said cover slip to said substantially planar surface of said platform to create a plurality of containment vessels for containing discreet volumes of sample; and
depositing one or more samples in said containment vessels.

27. The method of claim 26 further comprising the step of removing liquid from said sample.

28. The method of claim 26 further comprising the step of removing said cover slip from said planar surface.

29. The method of claim 26 further comprising the step of irradiating said samples.

30. A method of manufacturing a cover slip, comprising:
(a) obtaining an assembled mold apparatus comprising a base with affixed walls about said base;
(b) dispensing a suitable substrate material into said assembled mold apparatus; and
(c) allowing for a suitable period of time for curing.

31. The method of claim 30, wherein said base comprises one or more columns.

32. The method of claim 30, wherein said base comprises a combination of columns and plugs.
